(19) United States
(12) Patent Application Publication
(10) Pub. No.: US 2017/0120867 A1
(43) Pub. Date: May 4, 2017

(54) SYSTEM AND METHOD FOR TRIGGERED LATCH RELEASE

(71) Applicant: Ford Global Technologies, LLC, Dearborn, MI (US)

(72) Inventors: Brandon Beauvais, Dearborn, MI (US); Charles Everett Badger, II, Garden City, MI (US)

(21) Appl. No.: 14/926,933

(22) Filed: Oct. 29, 2015

(51) Int. Cl. B60R 25/24

(52) U.S. Cl. CPC B60R 25/24

(57) ABSTRACT

Various embodiments of the present disclosure provide a system and method for enabling a user to provide advanced notice to the vehicle that that the user will be approaching the vehicle within a designated period of time and automatically releasing a vehicle latch upon the arrival of the user at the vehicle. In one embodiment, the user's key fob is paired with a mobile device and the user's command is relayed from the key fob to the vehicle telematics control unit (TCU). The vehicle TCU communicates with the vehicle body control module to detect the key fob when the user arrives at the vehicle and to automatically release the latch upon the arrival of the user.

### TECHNICAL FIELD

This application generally relates to remote latch release of a vehicle. More specifically, the application relates to a triggered release of a latch, such to unlock the vehicle doors or release the trunk, when the vehicle user approaches the vehicle.

### BACKGROUND

Vehicles include various systems for a user to release various latch systems of the vehicle. For example, vehicles include systems to unlock the vehicle doors or release the trunk of the vehicle. In operation, a user of a vehicle may wish to open the doors, or the trunk or lift gate of their vehicle, but the users may not have a free hand to access keys or a handle. Some vehicles include a lever or button inside the vehicle, which is difficult for the user of the vehicle to access when the user does not have a free hand. Other vehicles include a kick release for a trunk under the car, which may also be difficult for a user that is carrying many objects or unable to sufficiently balance to engage the kick release.

Many vehicles include a remote keyless system (RKS) for enabling control of various vehicle functions, such as locking and unlocking the doors and releasing the trunk, without using a traditional key or other mechanical device, or otherwise making physical contact with the vehicle. Typically, remote keyless systems include a remote control comprising buttons or switches for enabling control of vehicle functions. The remote control may be in the form of an independent key fob separate from an ignition key of the vehicle, or a key fob built into the ignition key handle.

Conventional remote keyless systems typically include a remote keyless entry (RKE) system for enabling remote, keyless control of the vehicle's doors, including, releasing the trunk or tailgate. Many existing RKE systems are designed to enable control of additional vehicle functions through entry of a predetermined button sequence. For example, pressing the unlock button once may unlock only the driver's side door, while pressing the unlock button twice may unlock all vehicle doors.

With such systems, the user may not be able to activate a release on the key fob without any free hands. Another drawback of existing remote keyless systems is the limited operational range of the key fob or other remote control. Specifically, the key fob must be within a predetermined distance (e.g., 100 meters) of the vehicle in order to issue commands using the remote keyless system. Moreover, the actual, operational range of the key fob may be less than the predetermined distance due to various factors, including location, elevation, intermediate structures, and blocking obstacles. In cases where the operational range of the key fob is less than a user's current distance from the vehicle, the user must move closer, with any storage items in toe, in order to use the key fob.

Accordingly, there is still a need in the art for a vehicle key fob apparatus that has a wider communication range and allows quick and convenient control of the various latch systems of a vehicle.

### SUMMARY

Various embodiments of the present disclosure include a system and method for providing a triggered latch release upon approach of an authorized user. More specifically, various embodiments of the present disclosure include providing advance notice to a vehicle that a vehicle user will be approaching the vehicle within a designated period of time and automatically releasing the latch upon detection of the user at the vehicle.

In one embodiment, the triggered latch release system and method includes enabling a user to utilize a key fob to provide advanced notice to the vehicle that that the user will be approaching the vehicle within a designated period of time. In this embodiment, upon receiving the advanced notification, the vehicle body control module initiates sweeping for the key fob with a low-power antenna located near the trunk with a range of only a couple meters from the trunk. When the user enters the range of the antenna sweep, the vehicle detects the key fob, authenticates the key fob, and if authenticated, automatically releases the latch.

In one embodiment, the user's key fob is paired with a mobile device and the user's command is relayed from the key fob to a vehicle telematics control unit (TCU). More specifically, the user-inputted latch release command from the key fob is transmitted to a mobile device paired to the key fob, the mobile device sends the command to a remote server that transmits the command to the TCU of the vehicle associated with the key fob. The vehicle TCU communicates with the vehicle body control module to initiate sweeping for the signal from the key fob and when the user enters the range of the antenna sweep, the vehicle detects the key fob. After the vehicle detects the key fob, the vehicle releases the latch. Such a configuration enables a user to operate the triggered trunk release system from a greater distance from the car.

In various embodiments described herein, the system and method for providing a triggered latch release is applied to the trunk release of the vehicle (referred to hereinafter as “the triggered trunk release system and method of the present disclosure”). It should be appreciated that the system and method for providing a triggered latch release applies to various other latch systems of a vehicle, such as but not limited to the vehicle door latch release (both to unlock the vehicle door or open the vehicle door) and various other latch systems throughout the vehicle.

As will be appreciated, this disclosure is defined by the appended claims. The description summarizes aspects of the embodiments and should not be used to limit the claims. Other implementations are contemplated in accordance with the techniques described herein, as will be apparent to one having ordinary skill in the art upon examination of the following drawings and detail description, and such implementations are intended to within the scope of this application.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 is an illustration of an example wireless system for providing a triggered latch release upon approach of a vehicle, in accordance with certain embodiments.

FIG. 2 is a flow chart including example operations that may be implemented using the system of FIG. 1, in accordance with certain embodiments.

FIG. 3 is a flowchart including example operations that may be implemented using the system of FIG. 1, in accordance with certain embodiments.

FIG. 4 is a block diagram of an example vehicle computing system included in the vehicle of FIG. 1, in accordance with certain embodiments.

FIG. 5 is a block diagram of an example computing device included in one or more components of the wireless system of FIG. 1, in accordance with certain embodiments.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects.

Various embodiments of the present disclosure include a system and method for a providing a triggered latch release upon approach of an authorized user. More specifically, various embodiments of the present disclosure include providing advance notice to a vehicle that a vehicle user will be approaching the vehicle within a designated period of time and automatically releasing the latch upon detection of the user at the vehicle. In one embodiment, the triggered latch release system and method of the present disclosure includes enabling a user to utilize a key fob to provide advanced notice to the vehicle that that the user will be approaching the vehicle within a designated period of time. In this embodiment, upon receiving the advanced notification, the vehicle body control module initiates sweeping for the key fob with a low-power antenna located near the vehicle with a range of only a couple meters from the vehicle. When the user enters the range of the antenna sweep, the vehicle detects the key fob, authenticates the key fob, and if authenticated, automatically releases the latch.

In one embodiment, the user's key fob is paired with a mobile device and the user's command is relayed from the key fob to a vehicle telematics control unit (TCU). More specifically, the user-inputted latch release command from the key fob is transmitted to a mobile device paired to the key fob, the mobile device sends the command to a remote server that transmits the command to the TCU of the vehicle associated with the key fob. The vehicle TCU communicates with the vehicle body control module to initiate sweeping for the signal from the key fob and when the user enters the range of the antenna sweep, the vehicle detects the key fob. After the vehicle detects the key fob, the vehicle releases the latch. Such a configuration enables a user to operate the triggered latch release system from a greater distance from the car.

It should be appreciated that the system and method of the present disclosure may be applied to various latch systems of a vehicle, including but not limited to the vehicle door lock system and the vehicle trunk release system. In the embodiments described below, the system and method of the present disclosure are described as applied to a trunk release system.

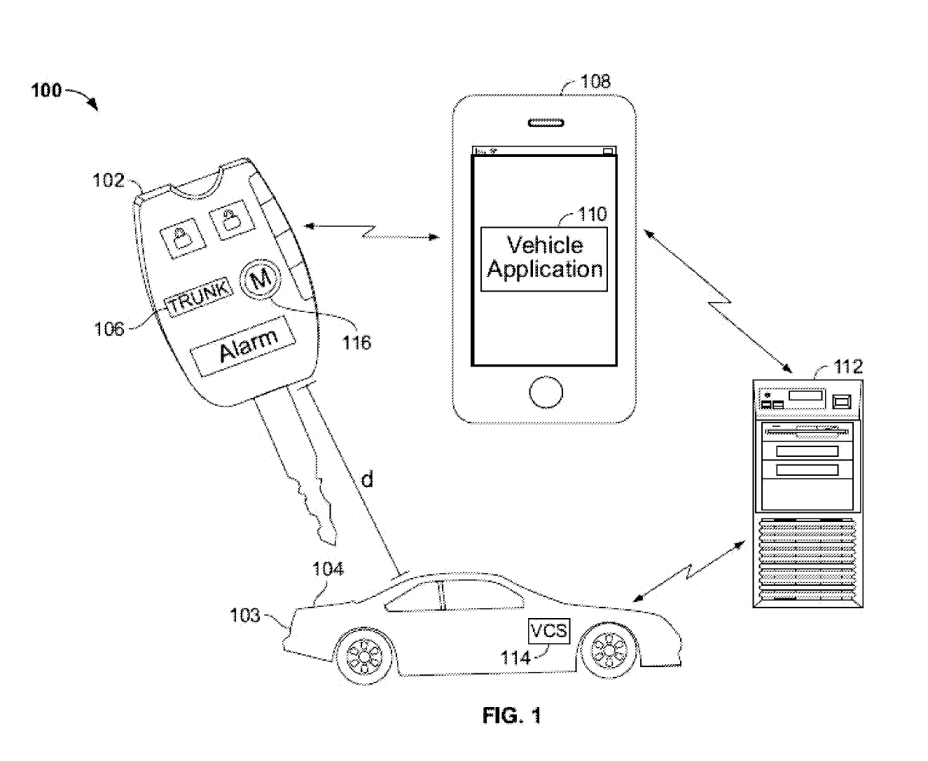

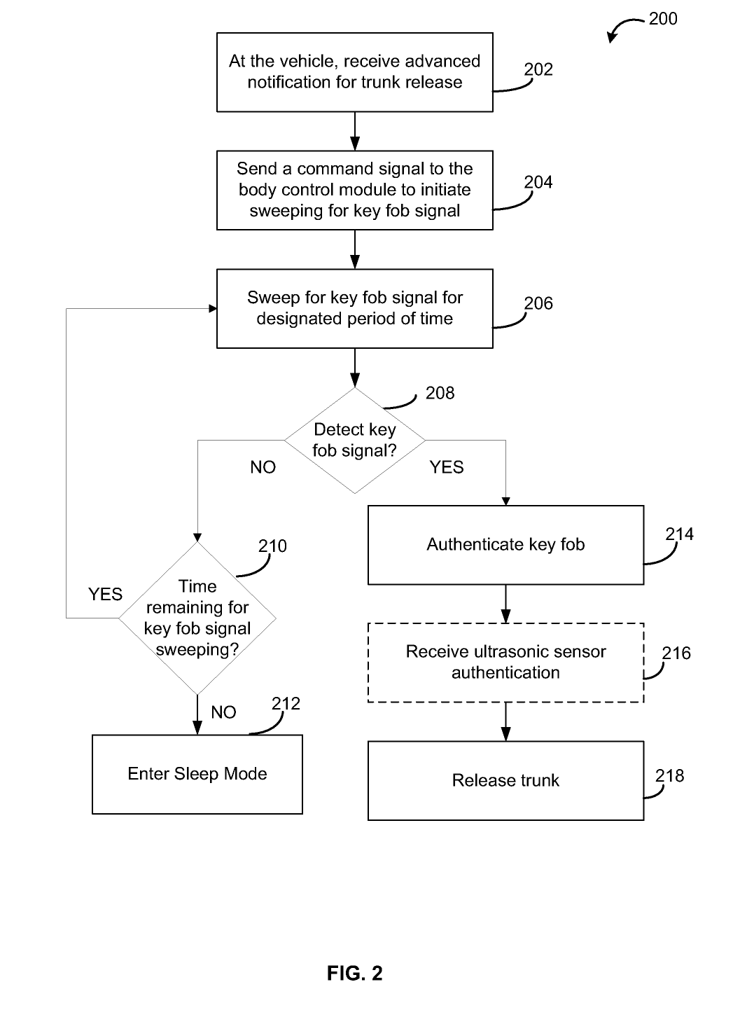

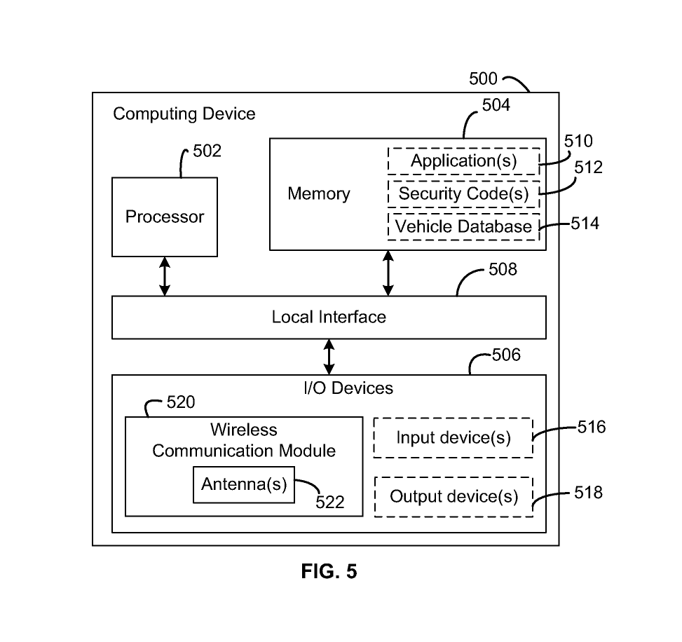

FIG. 1 illustrates an example wireless system 100 configured to provide a system and method for triggered trunk release in accordance with embodiments. Various components of the system 100 may be implemented using software executable by one or more servers or computers, such as a computing device 500 with a processor 502 and a memory 504 as shown in FIG. 5, which is described in more detail below. FIG. 2 illustrates one embodiment of a process 200 for providing a system and method for triggered trunk release in accordance with one or more principles of the invention. In the following paragraphs, the process 200 will be described in conjunction with a description of the various components of the system 100.

The vehicle key fob apparatus 102 (also referred to herein as a “key fob”) is configured to provide a user with remote, keyless control of various operations or functions of the vehicle including, but not limited to, opening and/or closing the trunk 103 of the vehicle 104. The key fob apparatus 102 may be pre-configured to enable direct control of various operations of the vehicle 104 by the vehicle manufacturer or an entity associated therewith. As will be appreciated, other vehicle functions may be controllable by the key fob 102, and the present disclosure is intended to cover any and all such key fob operations.

As shown in FIG. 1, the key fob 102 includes various input devices including a trunk release input device 106 that can be operated by the user to open the trunk of the vehicle 104. The vehicle input devices, such as the trunk release input device 106, can be any type of input device, including, but not limited to, buttons or push buttons, sliders, switches, knobs, dials, and/or touch input devices. In the illustrated embodiment, the trunk release input device 106 is a push button that can be selectively pressed by the user to release the trunk or lift gate of the vehicle.

In various embodiments, at least some vehicle functions are performed upon receiving a single user input at the vehicle input device for controlling said vehicle function, while other vehicle functions may be performed upon receiving a certain sequence or combination of inputs at one or more of the vehicle input devices. These combinational inputs can include, for example, sequential operation of two or more vehicle input devices and/or repeated operation of a single vehicle input device, such as, e.g., double-clicking the input device or holding down the input device for a preset time period. For example, in one embodiment of the present disclosure, the trunk release input device 106 is clicked once for to initiate authentication sweep, and clicked twice to immediately release the trunk.

Turning to FIG. 2, in operation, the method 200 begins at step 202, where the vehicle receives advanced notification for trunk release. The method 200 is initiated by the vehicle key fob apparatus, such as, for example, the key fob 102 of the wireless system 100. Further, the vehicle key fob apparatus may interact with one or more components of the system 100 to carry out the operations of the method 200. In this embodiment, the key fob 102 communicates directly with the vehicle 104 to provide advance notice to the vehicle 104 that that the user will be approaching the vehicle 104 within a designated period of time. More specifically, in one example embodiment, when a user double-clicks the trunk release input device 106, the key fob 102 transmits a command to the vehicle that the user will be approaching in a designated period of time and to release the trunk 103 upon arrival of the user.

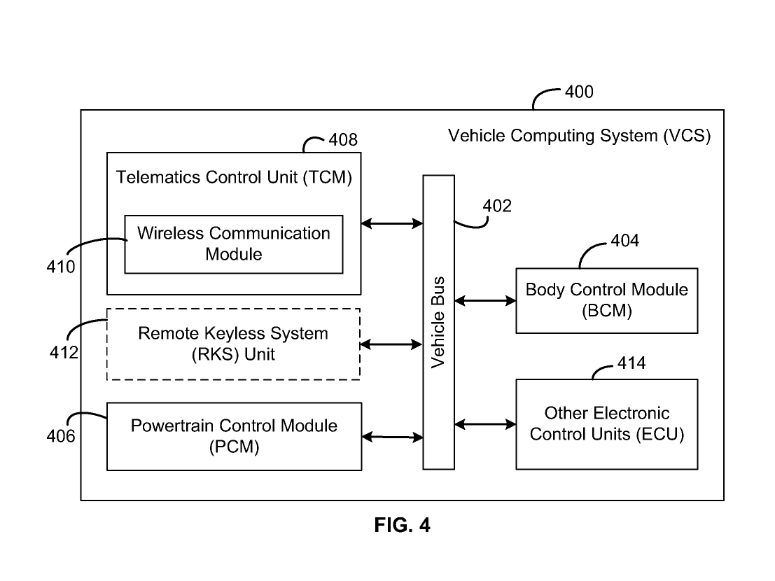

Upon receiving the advanced notification, the vehicle 104 searches for the key fob 102. More specifically, as described in greater detail below, the user's command is transmitted to a vehicle body control module 404 (as depicted in FIG. 4) to begin sweeping for the key fob 102, as indicated by step 204. In certain embodiments, the vehicle provides a feedback so that the user verifies that the delayed release signal was successfully received. In one example embodiment, after the user triggers the delayed trunk release, the key fob transmits a special, periodic signal to the vehicle so that the vehicle knows to sweep for the key fob. This signal would be sent at a designated periodic rate (such as, for example, once per second) and this signal will be transmitted for a designated predetermined period of time (such as, for example, for two minutes). In one embodiment, the vehicle sweeps for a signal from the key fob with a low-power antenna located near the trunk 103 with a range of only a couple meters from the trunk 103. As indicated by step 206, the antenna sweeps for the key fob signal for a designated period of time.

The designated period of time is the period of time within which the user is predicted to arrive at the vehicle. In this example embodiment, after the vehicle detects this signal, the vehicle begins key fob sweeps. The key fob sweeping terminates a predetermined period of time after the delay release signal is no longer detected or if interrupted by another key fob command or the actual release conditions of key fob detection in range of the trunk. More specifically, as indicated by decision diamond 208, if the antenna has not detected a signal from the key fob, the body control module determines whether there is any time remaining for the key fob signal sweeping, as indicated by decision diamond 510.

In certain embodiments, if the key fob supports two-way communication with the vehicle, the key fob can stop transmitting after receiving an acknowledgement from the vehicle. If a key fob is connected to a mobile, there will be two-way communication so the key fob will not even have to send the signal.

If the designated period of time has elapsed, and no signal has been detected, the antenna enters sleep mode, as indicated by step 212. In sleep mode, the antenna no longer searches for the key fob signal, and if the user wishes to initiate the triggered trunk release feature, the user must restart the feature by double-tapping on the trunk release input 106 again. Such a configuration is an added safety feature so that triggered trunk release system does not release the trunk unless the user is arrives at the vehicle, and also so that the antenna does not continue to search for the user if the user does not arrive during the designated period of time.

It should be appreciated that in certain embodiments, the designated period of time is predetermined. In other alternative embodiments, the user modifies the designated period of time to a desired period of time.

If on the other hand, at step 210, the vehicle body control module 404 determines that there is still time remaining, the antenna continues to sweep for the key fob signal. More specifically, the vehicle body control module causes an antenna within the vehicle to being sweeping for a signal from the key fob. In one embodiment, the antenna is a short range antenna located at the rear of the vehicle 104 such that the antenna detects the key fob signal when the key fob is within close proximity to the trunk of the vehicle 104.

If the antenna detects the signal from the key fob within the designated period of time, the antenna authenticates the key fob 102, as indicated by step 514. More specifically, the antenna authenticates the key fob 102 by verifying that the detected key fob 102 is the key fob 102 associated with the vehicle 104. Thus, even though the user initiates the delayed trunk release feature when the user is away from the vehicle, the triggered trunk release system only releases the trunk upon the arrival of the user at the vehicle. Such a configuration provides additional security features to prevent from theft or from prematurely releasing the trunk

In an alternative embodiment, the vehicle may utilize additional or different authentication methods. For example, in one embodiment, method 200 includes an optional step of receiving an ultrasonic sensor authentication, as indicated by step 216. In one embodiment, ultrasonic sensors may be located at the rear of the vehicle (near the trunk) and used to detect the physical presence of the user at the rear of the vehicle. In an embodiment including the added ultrasonic sensor authentication, the vehicle body control module does not release the trunk until the user is detected at the rear of vehicle. Such a configuration detects that both the key fob is within range, and that the user is near the trunk (i.e., at the back of the vehicle) as an added security feature. Once the key fob has been detected and authenticated, the body control module 404 releases the trunk 103, as indicated by step 518.

In other embodiments, the ultrasonic sensors are included as an additional authentication measure (in addition to key fob authentication). In another alternative embodiment, the ultrasonic sensors are included as an alternative authentication measure. More specifically, in one such embodiment, the vehicle utilizes the ultrasonic sensors to determine that the user has approached the trunk, and releases the trunk without searching for and/or authenticating the key fob. In another embodiment, the vehicle uses a camera instead of the ultrasonic sensors to determine that a user is approaching.

It should be appreciated that in the example embodiment described above, the user must be within a specified distance from the vehicle for the vehicle to receive the advance notification from the key fob. More specifically, referring to FIG. 1, the key fob 102 must be within a predetermined distance d of the vehicle 104 in order to wirelessly communicate commands, such as opening the trunk 103, to the vehicle 104. For example, in some cases, the predetermined, or manufacturer-provided, distance d may be about 100 meters. As will be appreciated, the distance d can be adversely affected by geographical, physical, and/or other various factors, including, for example, the existence of solid obstacles between the key fob 102 and the vehicle 104. In such cases, the actual, operational range of the key fob 102 can be less than the predetermined distance d. Further, in some cases, the operational range of the key fob 102 can be shorter than a user's distance from the vehicle 104. Thus, it is desirable to provide the triggered trunk release feature with a greater operational range.

In various alternative embodiments of the present disclosure, the wireless system 100 is configured to extend the operational range of the key fob 102 beyond the predetermined distance d by utilizing the vehicle telematics unit (TCU) and by sending vehicle commands from the key fob 102 to the vehicle 104 via the mobile device 108 and the remote server 112.

As further shown in FIG. 1, in various alternative embodiments of the present disclosure, the wireless system 100 further includes a mobile device 108 and a remote server 112. In one such embodiment, the mobile device 108 is paired to the key fob 102 using known wireless pairing techniques, including, for example, exchanging security codes stored in a memory (not shown) of the key fob 102 with the mobile device 108 for authentication by the vehicle 104. The mobile device 108 may communicate with the key fob 102 using Bluetooth, infrared, radio frequency identification (RFID), near field communication (NFC), or any other short-range wireless communication technology. The mobile device 108 may be any type of portable electronic device, including, for example, a smartphone or other mobile telephone, a tablet or tablet-type personal computer, a personal digital assistant (PDA), a smartwatch or other wearable device, and the like.

In some embodiments, the mobile device 108 includes a software application 110 that is configured to at least communicate vehicle commands received from the key fob 102 to a remote server 112. The software application 110 (also referred to here as a “vehicle application”) can be a mobile client that is developed by, and/or associated with, the vehicle manufacturer, and can be customized for the vehicle 104. In some cases, the vehicle application 110 is specifically designed for pairing the key fob 102 to the mobile device 108 and for automatic trunk release feature on the key fob 102, as described below in more detail. In other cases, the vehicle application 110 also provides a graphical user interface for accessing a remote keyless system (RKS) of the vehicle 104. In still other cases, the vehicle application 110 additionally provides diagnostic and/or performance information about the vehicle 104. In embodiments, all or a portion of the vehicle application 110 can be stored in a memory (not shown) of the mobile device 108.

As shown in FIG. 1, the remote server 112 can be communicatively coupled to the mobile device 108 and a vehicle computing system (VCS) 114 of the vehicle 104 via a wireless communication network, such as, for example, a WiFi network or other wireless Ethernet, cellular network, and/or satellite. In embodiments, the remote server 112 can be a cloud computing device, or can be included in a cloud computing network, both of which may be controlled by, and/or associated with, the vehicle manufacturer. In some embodiments, a secure, wireless communication channel may be pre-established between the VCS 114 and the remote server 112 in order to enable direct communication between the vehicle 104 and the server 112 without the need for pairing or authorization before each key fob operation. The secure communication channel may be established by, or under the supervision of, the vehicle manufacturer.

The remote server 112 can include a vehicle database (not shown) for storing vehicle information received from the VCS 114 of the vehicle 104, as well as other information associated with the vehicle 104, including, for example, global positioning system (GPS) data for the vehicle 104 received from a GPS server, a charging profile for the vehicle 104, a key profile for each key associated with the vehicle 104, fuel economy and driving habits associated with each key, etc. In some embodiments, a portion of the vehicle application 110 resides on the remote server 112. In some embodiments, the remote server 112 supplies images and/or information for implementing the vehicle application 110 on the mobile device 108. The remote server 112 can also store one or more software applications designed for interacting with the vehicle application 110 and the VCS 114, including receiving commands from the vehicle application 110 and submitting the same to the VCS 114, as will be explained in more detail below.

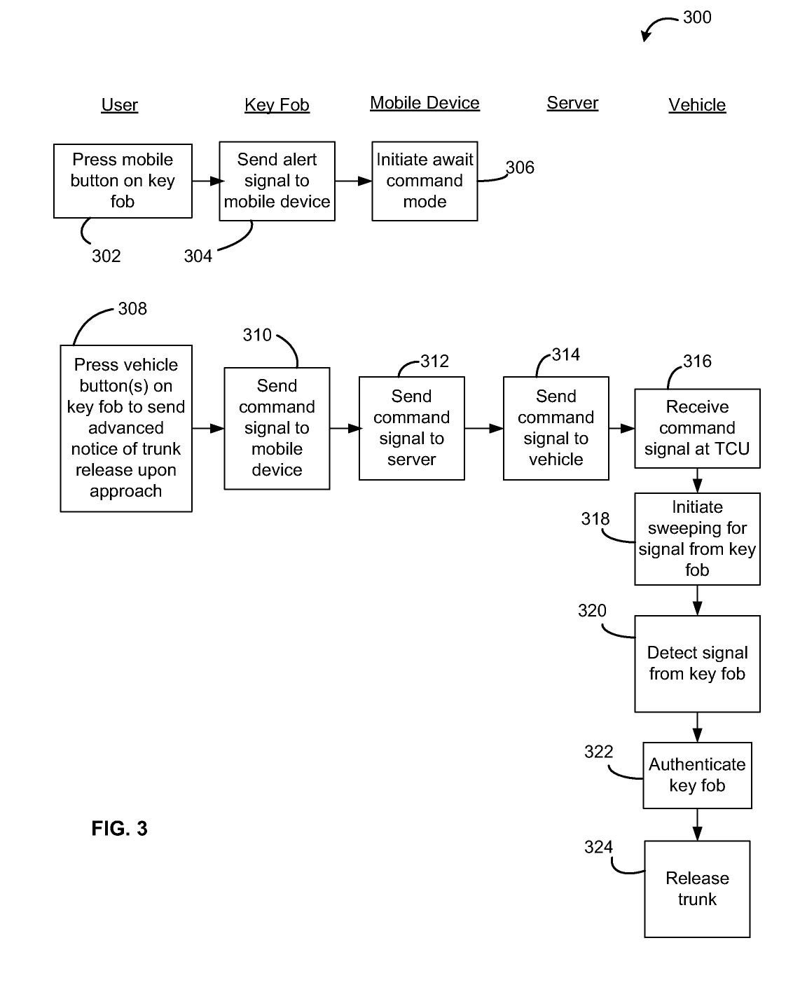

Turning to FIG. 3, which illustrates one embodiment of a process 300 for providing a system and method for triggered trunk release, in accordance with one or more principles of the invention. The process 300 may be implemented using the system 100, or more specifically, through interactions between various components of the system 100 that are facilitated by software executing on one or more computer processors (not shown) associated with said components. In the following paragraphs, the process 300 will be described in conjunction with a description of the various components of the system 100 as depicted in FIG. 1.

Process 300 includes utilizing a mobile device 108 and remote server 112 to increase the operational range of the key fob 102. In certain embodiments, prior to initiating the triggered trunk release feature, the key fob must be linked to the mobile device, as depicted by steps 302 to 306 of process 300. More specifically, as shown in FIG. 1, the key fob 102 includes a mobile link input device 116 that is configured to initiate communication with the vehicle via the mobile device. In one embodiment, the mobile link input device 116 is a dedicated input device for alerting the mobile device 108 to expect the user to send a command signal from the key fob 102. In some cases, the mobile link input device 116 can be located on the key fob 102 adjacent to the vehicle input devices 106, as shown in FIG. 1. In other cases, the mobile link input device 116 can be located on any other side of the key fob 102, including, for example, on a left, right, or back side of the key fob 102. In the illustrated embodiment, the mobile link input device 116 (also referred to herein as a “mobile button”) is shown as a push button that can be pressed down to activate the mobile link mode of the key fob 102. In other embodiments, the mobile link input device 116 can be any other type of input device, including, but not limited to, a switch, knob, slider, or dial.

Process 300 includes user selection of the mobile button 116 on the key fob 102, at step 302. The key fob 102 sends an alert signal to the mobile device, at step 304. Upon receipt of the alert signal, at step 306, the mobile device 108, and/or the vehicle application 110, enters an await command mode, or otherwise waits for the key fob 102 to send a signal commanding the vehicle 104 to perform some action, such as, but not limited to releasing the trunk. The await command mode can cause the mobile device 108 and/or the vehicle application 110 to automatically transmit, to the remote server 112, any vehicle command to release the trunk received from the key fob 102 within a predetermined time period following selection of the mobile button 116.

As further depicted in FIG. 3, a vehicle command may be input into the key fob 102 at step 308 upon user-selection of the trunk release input device 106. In one example embodiment, the user initiates the delayed trunk release feature by double-clicking the trunk release input device 106. At step 310, the key fob 102 sends a trunk release command signal to the mobile device 108. At step 312, the mobile device 108, and/or the vehicle application 110, sends the trunk release command signal to the remote server 112. At step 314, the remote server 112 sends the received command signal to the VCS 114 of the vehicle 104. At step 316, a telematics control unit (TCU) of the VCS 114 receives the command signal.

At step 318, the TCU communicates with the vehicle body controller to initiate sweeping for the key fob 102. At step 320, the key fob 102 is detected by the vehicle body controller. At step 322, the vehicle body controller authenticates the key fob 102. More specifically, the vehicle body controller confirms that the key fob 102 detected is associated with the vehicle. If the vehicle body controller verifies that the key fob 102 is detected and authenticated, the vehicle body controller causes the trunk to be released, as illustrated at step 324.

In certain embodiments, the process 300 is further configured to include a time out feature (not shown) in case a user does not approach the vehicle after pressing the trunk release input device 106. In such cases, the vehicle body controller terminates the sweeping for the key fob 102 signal if no key fob 102 signal is detected within a designated period of time.

In one alternative embodiment, the system and method of the present disclosure includes priming the key fob. More specifically, the user uses the key fob to perform a vehicle command. If the key fob is out of range of the vehicle, the key fob would continue to repeat the command. In certain embodiments, the user may modify the setting under which the key fob command is repeated. For example, the command may be set to repeat a predetermined number of times, or may be set to repeat at a predetermined interval for a predetermined period of time, or may be set to continue repeating at a predetermined interval until receiving a positive response that the vehicle received the request. Such a configuration enables the user to double-tap the trunk input and then put the key fob away as the user walks towards the car. Once in range, the key fob automatically triggers the request, and then any subsequent actions (as described above) could be initiated.

In certain embodiments, the triggered trunk release system and method includes a valet mode during which the triggered trunk release feature will not be available. That is, in the valet mode, the user may not double click the trunk release input device 106 for a delayed trunk release. Such a configuration provides a security feature to prevent unauthorized trunk releases.

Referring now to FIG. 4, which illustrates an example vehicle computing system (VCS) 400 that may be included in the vehicle 104 as the VCS 114 shown in FIG. 1, in accordance with embodiments. The VCS 400 includes various electronic control units (ECUs) that are responsible for monitoring and controlling the electrical systems or subsystems of the vehicle 104, as described in more detail below. In embodiments, the ECUs of the VCS 400 are interconnected by a vehicle bus 402 (such as, e.g., a controller area network (CAN) bus) for passing data to and from the various ECUs, as well as other vehicle and/or auxiliary components in communication with the VCS 400. Each ECU may include, for example, one or more inputs and outputs for gathering, receiving, and/or transmitting data, a memory for storing the data, and a processor for processing the data and/or generating new information based thereon.

In the illustrated embodiment, the VCS 400 includes a body control module (BCM) 404 for controlling and monitoring various electronic accessories in a body of the vehicle 104. In various embodiments, the BCM 404 is an ECU that controls, among other vehicle components, the trunk and doors of the vehicle 104, including locking, unlocking, opening, and/or closing said doors. The BCM 404 can be configured to implement vehicle commands received from the key fob 102 that are related to the doors, windows, or other body components controlled by the BCM 404.

As shown in FIG. 4, the VCS 400 further includes a telematics control unit (TCU) 408, which is an ECU for enabling the vehicle 104 to connect to various wireless networks, including, for example, GPS, WiFi, cellular, Bluetooth, NFC, RFID, satellite, and/or infrared. In embodiments, the TCU 408 (also referred to as a “vehicle telematics unit”) includes a wireless communication module 410 comprising one or more antennas, radios, modems, receivers, and/or transmitters (not shown) for connecting to the various wireless networks. For example, the wireless communication module 410 can include a mobile communication unit (not shown) for wirelessly communicating over a cellular network (e.g., GSM, GPRS, LTE, 3G, 4G, CDMA, etc.), an 802.11 network (e.g., WiFi), a WiMax network, and/or a satellite network. The TCU 408 can also be configured to control tracking of the vehicle 104 using latitude and longitude values obtained from a GPS satellite.

In embodiments, the TCU 408 receives external data, including vehicle commands, via the wireless communication module 410 and provides the external data to an appropriate ECU of the VCS 400. For example, if the TCU 408 receives a trunk release command, the TCU 408 sends the command to the BCM 404 via the vehicle bus 402. In some embodiments, the TCU 408 also receives internal data from other ECUs of the VCS 400, or a processor (not shown) of the VCS 400, with instructions to transmit the internal data to the remote server 112, or another component of the wireless system 100.

The wireless communication module 410 can be capable of wirelessly communicating over two or more networks to ensure continuity of network access, for example, in case one of the networks fail or are out of range. Moreover, the vehicle commands may be received at different receivers of the wireless communication module 410 depending on the wireless communication technology being used to transmit the command. For example, commands and/or data transmitted by the key fob 102 to the vehicle 104 may be received at a Bluetooth receiver (not shown) of the wireless communication module 410. As another example, commands and/or data transmitted by the remote server 112 to the vehicle 104 may be received at a cellular or WiFi receiver (not shown) of the wireless communication module 410. Likewise, data may be transmitted from the TCU 408 to the key fob 102 using a Bluetooth transmitter (not shown) included in the wireless communication module 410, and data may be transmitted from the TCU 408 to the remote server 112 using a cellular or WiFi transmitter (not shown) included in the wireless communication module 410. In embodiments, the VCS 400 may be transparent to the source of, or the transmission path used to send, the vehicle command to the vehicle 104. For example, the VCS 400 may treat vehicle commands received directly from the key fob 102 no differently than vehicle commands received via the transmission path 115.

The VCS 400 can further include a remote keyless system (RKS) unit 412 for controlling and monitoring remote, keyless interactions between the key fob 102 and the vehicle 104. The RKS unit 412 can include a remote keyless entry system and in some cases, a remote keyless ignition system. In the latter case, the RKS unit 412 may also be referred to as a “passive entry passive start (PEPS) system.” In some embodiments, the RKS unit 412 is a separate, stand-alone ECU that is interconnected to the BCM 404, PCM 406, TCU 408, and other ECUs 414 of the vehicle 104 via the vehicle bus 402 in order to carry out the RKS/PEPS operations. For example, the RKS unit 412 may receive vehicle commands from the key fob 102 via the TCU 408, process the commands to identify the appropriate ECU for carrying out the command, send the command to the identified ECU, and confirm performance of the command. In other embodiments, the RKS unit 412 may be comprised of multiple segments that are incorporated into various ECUs of the VCS 400, such as, for example, the BCM 404, the PCM 406, and/or the TCU 408, to process the RKS/PEPS commands received at each ECU. In still other embodiments, the RKS unit 412 may be included within one ECU, such as, e.g., the TCU 408, in order to handle or process RKS/PEPS commands as they are received by the wireless communication module 410 of the TCU 408.

Referring back to FIG. 5, shown is an example computing device 500 for processing data or other inputs associated with the wireless system 100, for housing and executing software used to facilitate the wireless system 100, the method 200 and/or the process 300 and/or for communicating with other components of the wireless system 100, in accordance with embodiments. One or more instances of the computing device 500 may be utilized to implement any, some, or all of the components in the system 100. In some embodiments, portions of the system 100 are implemented in software, as an executable program, and are executed by one or more special or general purpose digital computer(s), such as a mainframe computer, personal computer (desktop, laptop, or tablet-type computer), personal digital assistant, workstation, minicomputer, computer network, virtual network, Internet cloud computing facility, mobile telephone or smartphone, tablet, or other handheld computing device. In such cases, the computing device 200 may be representative of any computer in which the system 100 resides or partially resides.

As an example, the computing device 500 may represent a computer included in the key fob 102 for receiving vehicle command inputs and communicate with the vehicle 104 and/or the mobile device 108. Likewise, the computing device 500 may represent a computer included in the mobile device 108 for storing, executing, and displaying the vehicle application 110, and communicating with the key fob 102 and the remote server 112. As another example, the computing device 500 may represent a computer included in the remote server 112 for interfacing with the mobile device 108 and communicating vehicle commands to the vehicle 104. Further, the computing device 500 may represent a computer included in the VCS 114 of the vehicle 104 for communicating with the key fob 102 and the remote server 112, as well as receiving, processing, and executing vehicle commands received therefrom.

As shown in FIG. 5, the computing device 500 generally includes a processor 502, a memory 504, and one or more input and/or output (I/O) devices 506 (or peripherals) that are communicatively coupled via a local interface 508. The processor 502 is a hardware device and can be any custom made or commercially available processor, a central processing unit (CPU), an auxiliary processor among several processors associated with the computer 500, a semiconductor based microprocessor (in the form of a microchip or chip set), another type of microprocessor, or generally any device for executing software instructions. When the computing device 500 is in operation, the processor 502 can be configured to execute software stored within the memory 504, to communicate data to and from the memory 504, and to generally control operations of the computing device 500 pursuant to the software. The software, in whole or in part, but typically the latter, may be read by the processor 502, buffered within the processor 502, and then executed.

The memory 504 may include a computer readable medium for storing software for implementing the system 100, and/or components thereof, and for implementing particular system transactions. For example, the memory 504 may be configured to store one or more separate programs (e.g., source program, executable program (object code), or script) comprising ordered listings of executable instructions for implementing logical functions associated with the system 100. Furthermore, the software can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, Python, and Lua. Components of the system 100 may also be written in a proprietary language developed to interact with these known languages. In the context of this document, a “computer-readable medium” may be any means that can store, communicate, propagate, or transport data objects for use by or in connection with the wireless system 100, and can even include paper having programming instructions printed thereon.

In some cases, the software in the memory 504 includes one or more applications 510 that are associated with the wireless system 100 and configured to implement the transmission path 115. As an example, in the memory 504 of the mobile device 108, the application(s) 510 can include all or a portion of the vehicle application 110. As another example, in the memory 504 of the key fob 102, the application(s) 510 include a mobile link application for implementing the method 500, or otherwise detect user-selection of the mobile link button 116 and send vehicle commands received thereafter to the mobile device 108. In some cases, the memory 504 of the key fob 102 can also store one or more security codes 512 that are uniquely associated with the vehicle 104 and enable the key fob 102 to remotely command certain vehicle operations. In yet another example, in the memory 504 of the server 112, the application(s) 510 include software designed to interface with the mobile device 108 and provide received vehicle commands to the telematics control unit (TCU) 408, or the VCS 114/400, of the vehicle 104. The memory 504 of the server 112 can also be utilized to implement one or more databases, such as, for example, a vehicle database 514 configured to store information associated with the vehicle 104, including for example, diagnostic information received from the TCU 408, GPS information received from a GPS satellite and associated with the vehicle 104, user account information related to the vehicle application 110, and the like.

In embodiments, the memory 504 includes any one or a combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 504 may incorporate electronic, magnetic, optical, and/or other types of storage media. In some cases, the memory 504 can have a distributed architecture where various components are situated remote from one another, but are still accessed by the processor 502.

The local interface 508 may be, for example, but is not limited to, one or more buses or other wired or wireless connections, as is known in the art. The local interface 508 may have additional elements, which are omitted for simplicity, such as controllers, buffers (caches), drivers, repeaters, and receivers, to enable communications. Further, the local interface 508 may include address, control, and/or data connections to enable appropriate communications among the other computer components.

The I/O devices 506 may include interactive hardware that is internal to the computing device 500, or external and connected wirelessly or via connection cable and/or I/O ports. The I/O devices 506 can include input devices 516, for example but not limited to, input modules for programmable logic controllers (PLCs), a keyboard, mouse, scanner, microphone, touchscreens, stylus, radio-frequency device readers, input hardware (e.g., buttons, switches, sliders, knobs, dials, and the like; such as, for example, the vehicle input devices 106 and the mobile input device 116), etc. Furthermore, the I/O devices 506 may also include output devices 518, for example but not limited to, output modules for PLCs, displays, haptic devices (e.g., actuators), lights (e.g., LEDs; such as, for example, the output devices 117), audio output devices (e.g., speakers), etc.

The I/O devices 506 further comprise devices that communicate with both inputs and outputs, including, but not limited to, a wireless communication module 520. The wireless communication module 520 includes one or more antennas 522 configured to wireless transmit signals to, and/or receive signals from, at least other components of the wireless system 100. The wireless communication module 520 further includes one or more receivers, transmitters, and/or transceivers (not shown) that are communicatively coupled to the one or more antennas 522 for processing the received signals, providing the transmitted signals, or otherwise facilitating wireless communication with other components of the wireless system 100. The wireless communication module 520 may also include a modulator/demodulator (modem; for accessing another device, system, or network, such as, e.g., another component within the wireless system 100), a bridge, and/or a router.

The exact type of wireless communication technology included in the wireless communication module 520 can vary depending on the computing device 500 and may include at least one of short-range wireless communication technology (such as, e.g., radio frequency (RF), Bluetooth, infrared, and/or NFC technology) and longer-range or broadband wireless communication technology (such as, e.g., WiFi, WiMax, other wireless Ethernet, cellular, GPS, and/or satellite technology). In some cases, the wireless communication module 520 may include more than one antenna and corresponding transceiver in order to communicate over different wireless networks. For example, the mobile device 102 may use Bluetooth technology to communicate with the key fob 102 and WiFi and/or cellular technology to communicate with the remote server 112.

In some cases, the computing device 500 can also include hardware for implementing one or more aspects of the techniques described herein. In such cases, the hardware utilizes any of the following technologies, or a combination thereof, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Thus, the systems and methods described herein can establish an extended communication range between a vehicle key fob apparatus and the vehicle associated therewith by relaying vehicle commands entered into the key fob through a transmission path that includes a mobile device securely paired to the key fob and a remote server securely connected to the vehicle's telematics system. More specifically, the key fob 102 and the wireless system 100, can maintain the intuitiveness and convenience of a typical key fob, but also provide an extended communication range that, for example, is limited only by the reach of cellular, satellite, and/or wireless Ethernet networks.

In certain embodiments, the process descriptions or blocks in the figures, such as FIGS. 3 and 5, can represent modules, segments, or portions of code which include one or more executable instructions for implementing specific logical functions or steps in the process. Any alternate implementations are included within the scope of the embodiments described herein, in which functions may be executed out of order from that shown or discussed, including substantially concurrently or in reverse order, depending on the functionality involved, as would be understood by those having ordinary skill in the art.

The system and method of the present disclosure are described as applied to a trunk release system. It should be appreciated that the system and method of the present disclosure may be applied to various latch systems of a vehicle, including but not limited to the vehicle door latch system. For example, in one alternative embodiment the system and method described above is applied to the door lock/unlock system. In another alternative embodiment, as part of the door unlock feature, if the vehicle has doors that are capable of self-opening when unlatched, the system and method of the present disclosure is applied to release the vehicle doors. More specifically, in one example embodiment, the user may triple tap the unlock button for a delayed door release command. When the user approaches the vehicle, the vehicle sweeps for the key fob. Once the vehicle detects the key fob, the vehicle authenticates the key fob, and if authenticated, the vehicle automatically unlocks and releases the driver's door.

It should be emphasized that the above-described embodiments, particularly, any “preferred” embodiments, are possible examples of implementations, merely set forth for a clear understanding of the principles of the invention. Many variations and modifications may be made to the above-described embodiment(s) without substantially departing from the spirit and principles of the techniques described herein. All such modifications are intended to be included herein within the scope of this disclosure and protected by the following claims.

1. A vehicle latch release system, comprising:
a key fob configured to transmit a latch release signal to a mobile device,
the mobile device configured to transmit the received signal to a vehicle telematics unit via a remote server, and
the telematics unit being configured to:
in response to receiving the latch release signal, relay a signal to initiate sweeping for the key fob; and
upon detecting the key fob, release the latch.

2. The vehicle latch release system of claim 1, wherein the telematics unit is in communication with a body control module.

3. The vehicle latch release system of claim 2, wherein the body control module is configured to detect the presence of the key fob by sweeping for a signal from the key fob.

4. The vehicle latch release system of claim 2, wherein the body control module is configured to release the latch in response to the detection of the presence of the key fob.

5. The vehicle latch release system of claim 4, wherein the body control module is in communication with an antenna that sweeps for the key fob.

6. The vehicle latch release system of claim 5, wherein the antenna sweeps for a predetermined period of time.

7. The vehicle latch release system of claim 2, wherein the body control module is configured to authenticate the key fob by verifying the key fob is associated with the vehicle.

8. A vehicle latch release system, comprising:
a vehicle telematics unit is configured to operate with a vehicle body control module to:
a) receive a latch release signal from a user;
b) in response to the received signal, sweep for a key fob; and
c) release a latch of the vehicle after the vehicle detects the presence of the key fob.

9. The vehicle latch release system of claim 8, wherein the user sends the latch release signal from the key fob.

10. The vehicle latch release system of claim 8, wherein the body control module is in communication with an antenna that sweeps for the key fob.

11. The vehicle latch release system of claim 10, wherein the antenna sweeps for a predetermined period of time.

12. The vehicle latch release system of claim 11, wherein the antenna is a low-powered antenna located near the rear of the vehicle near the latch.

13. The vehicle latch release system of claim 8, wherein the body control module is configured to authenticate the key fob by verifying the key fob is associated with the vehicle.

14. The vehicle latch release system of claim 9, wherein the key fob is paired with a mobile device, and the mobile device is paired with a remote server, and the remote server is in communication with the telematics unit.

15. A vehicle latch release method comprising:
receiving at a telematics unit, advanced notice of a latch release request from a user;
in response to the notice, initiating, at the vehicle, sweeping for a key fob; and
upon detection of the key fob at the vehicle, causing a body control module to release the latch of the vehicle.

16. The vehicle latch release method of claim 15, wherein receiving the advanced notice includes receiving a latch release signal from the key fob.

17. The vehicle latch release method of claim 15, wherein sweeping for the key fob includes the body control module causing an antenna to sweep for the key fob.

18. The vehicle latch release method of claim 17, wherein the antenna sweeps for a predetermined period of time.

19. The vehicle latch release method of claim 17, wherein the antenna is a low-powered antenna located near the rear of the vehicle near the latch.

20. The vehicle latch release method of claim 15, wherein the body control module is configured to authenticate the key fob by verifying the key fob is associated with the vehicle.
